(19) United States
(12) Patent Application Publication
(10) Pub. No.: US 2007/0270727 A1
(43) Pub. Date: Nov. 22, 2007

(54) Apparatus, systems, and methods for continuous pressure technique therapy

(76) Inventor: David Khorassani Zadeh, Eau Bonne (FR)

Correspondence Address: MUELLER AND SMITH, LPA;MUELLER-SMITH BUILDING, 7700 RIVERS EDGE DRIVE, COLUMBUS, OH, 43235, US

(21) Appl. No.: 11/642,092

(22) Filed: Dec. 20, 2006

(30) Foreign Application Priority Data
Dec. 21, 2005 (EP) 05112563.1

(51) Int. Cl. A61H 7/00; A61H 15/00

(52) U.S. Cl. 601/120; 601/134; 601/135

(57) ABSTRACT

The invention provides a device for applying a non-invasive therapeutically reproducible pressure massage to skin and underlying tissues of the animal body. A Continuous Pressure Technique device and fitted attachable accessory components are provided for use with massage therapy on for a variety of target tissues of the patient body. Said accessory components include features allowing the induction of a therapeutically adequate profound pressure with relatively little effort enabling a therapist to treat a number of treatment targets, and a number of patients without excessive fatigue to the therapist. The provided CPT device provides for the capability of remotely determining pressure applied to the patient body simultaneously with use of the device.

The invention, a Continuous Pressure Therapy, “CPT therapy” method system and device along with accessories supports the therapist by multiplying his exerted force, thus allowing induction of a profound pressure as effortlessly as possible and leading to a reproducible, adequate, quantitative, highly-localized and/or a continuous pressure to any targeted part of body. The devices of the invention can be used with a variety of different types of massage therapy as noted above. Additionally the CPT device used for Continuous Pressure Therapy provides new concepts and therapies for improved patient response and are applicable in the fields of prevention, evaluation and therapy of locomotor diseases.

### CROSS-REFERENCE TO RELATED APPLICATIONS

This application claims priority to pending European Application No. 05112563.1, filed Dec. 21, 2005.

### STATEMENT REGARDING FEDERALLY SPONSORED RESEARCH

Not Applicable.

### BACKGROUND OF THE INVENTION

Massage can be defined as the manipulation of the soft tissues of the body for therapeutic purposes. A system of strokes is used, including gliding, kneading, friction, pressure and vibrating. In addition, massage therapists may use auxiliary mechanical devices. Massage can provide several benefits to the body such as increased blood flow, reduced muscle tension and neurological excitability, increase muscle compliance resulting in increased range of joint motion, decreased passive or active stiffness and increase or decrease neural excitability. Changes in parasympathetic activity and hormonal levels following massage result in a relaxation response. See:
Weerapong P, Hume P A, Kolt G S., “The mechanisms of massage and effects on performance, muscle recovery and injury prevention.” Sports Med. 35(3):235-56 (2005).

Massage therapy aids in the healing process from injury or over-use, and is an excellent form of preventive health care. Its purpose is to develop, maintain, rehabilitate or augment physical function and relieve pain. Massage therapy modalities include, but not limited to hydrotherapy, remedial exercise, myofascial and trigger point therapy.

There are a variety of different types of massage known to those skilled in the art of massage and pressure therapy: Cyriax Techniques, neuromuscular techniques (Myofascial Trigger Point Therapy, myotherapy), others soft tissue techniques (Chill-and-Stretch Technique, Deep Tissue Release, Ischaemic Compression, Elbow Technique, etc), sports massage, and acupressure among others.

Specific soft tissue mobilisation is used to restore a tissue's ability to cope with the loading placed upon it. It uses graded and progressive applications of force, matched as closely as possible to the stage of the healing process, to return the tissue to its previous tensile strength. Myofascial pain syndrome (MPS) is a common condition often resulting in referral to a pain clinic. The incidence of MPS with associated pain trigger points appears to vary between 30% and 85% of people presenting to pain clinics, and the condition is more prevalent in women than in men. Patients experiencing MPS complain of regional persistent pain, ranging in intensity and most frequently found in the head, neck, shoulders, extremities, and low back. Muscle histologic, electromyographic, thermographic, and pressure abnormalities are inconsistently identified as abnormalities associated with MPS. Clinicians have employed multidimensional approaches to treatment, including trigger-point release, trigger-point injections, dry needling, stretch and spray, and transcutaneous electrical nerve stimulation while attempting to provide pain relief in MPS patients.

Myofascial trigger points (MTP) are recognized as hyperirritable tender spots in palpable tense bands of skeletal muscle. Muscles and muscle groups typically have a characteristic referred pain pattern. Trigger points (TP) are foci in muscle tissue. They are painful on compression and trigger pain in a referred area. The area of referred pain may be the only location of pain complaint in humans.

Acupuncture and acupressure are physical therapy techniques with a long history of effectiveness in the treatment certain individuals. In humans, 71% of the described trigger points are also known acupuncture points. Trigger point treatment may consists of TP stimulation with non-invasive means, such as massage or by invasive means, such as dry needling or injections to treat trigger points. Myofascial trigger point pain symptoms follow muscle overload, and can be activated acutely by sudden overload, or develop gradually with prolonged contractions or repetitive activity. The skill required to accurately diagnose MTP derived pain depends on palpation ability, training, and extensive clinical experience. Effective non-invasive treatment methods include manual stretching by trigger-point pressure release, contract-relax, and vapor coolant spray-and-stretch techniques, and dry needling or injection of MTPs.

Rivner showed that trigger points are found at the muscle spindle. This theory may explain the effects of alpha-adrenergic antagonists at the trigger point. Another theory consists in the fact that trigger points represent hyperactive end-plate regions, as the EMG activity recorded at trigger points resembles that described at the end-plate region. Trigger point injections of botulinum toxin type A which inhibits muscle contraction by blocking the release of acetylcholine from peripheral nerves, appears to be an effective treatment for focal myofascial pain disorders. Lund et al demonstrated that in patients with primary fibromyalgia, the muscle oxygenation is abnormal or low, at least in the trigger point area of the muscles.

Ischemic compression therapy provides alternative treatments leading to an immediate pain relief and myofascial trigger points sensitivity suppression. Therapeutic combinations such as hot pack plus active range of motion and stretch with spray, as well as TENS, and hot pack plus active range of motion and interferential current as well as myofascial release technique, are effective for easing myofascial trigger points pain and increasing cervical active range of motion. Ischaemic compression can be used as a prophylactic (preventive) measure in athletes. A program, consisting of ischemic pressure and sustained stretching, or trigger-point warming was shown to be effective in reducing trigger points sensitivity and pain intensity in individuals with neck and upper back pain. It has been shown that with deep tissue/deep pressure massage therapy technique, including neuromuscular trigger point, in patients with avascular necrosis of the hip joints has a salutary effect on pain relief and quality of life.

For additional background, refer to:
Simons D G, Mense S. Diagnosis and therapy of myofascial trigger points. Schmerz. 17(6): 419-24 (2003 December).
Rivner M H. The neurophysiology of myofascial pain syndrome. Curr Pain Headache Rep. 5(5): 432-40 (2001 October).
Cheshire W P, Abashian S W, Mann J D. Botulinum toxin in the treatment of myofascial pain syndrome. Pain. 59(1): 65-9 (1994 October).
Lund N, Bengtsson A, Thorborg P. Muscle tissue oxygen pressure in primary fibromyalgia. Scand J Rheumatol. 15(2):165-73 (1986).
Hou C R, Tsai L C, Cheng K F, Chung K C, Hong C Z. Immediate effects of various physical therapeutic modalities on cervical myofascial pain and trigger-point sensitivity. Arch Phys Med Rehabil. 83(10): 1406-14 (2002 October).
Vecchiet L et al, ‘Latent myofascial trigger points: Changes in muscular and subcutaneous pain thresholds at trigger point and target level’, J of Manual Medicine 5(4) (1990).
Hanten W P, Olson S L, Butts N L, Nowicki A L. Effectiveness of a home program of ischemic pressure followed by sustained stretch for treatment of myofascial trigger points. Phys Ther. 81(4): 1059-60 (2001 April).
Albright G L, Fischer A A. Effects of warming imagery aimed at trigger-point sites on tissue compliance, skin temperature, and pain sensitivity in biofeedback-trained patients with chronic pain: a preliminary study. Percept Mot Skills. 71(3 Pt 2): 1163-70 (1990 December).
Bodhise P B, Dejoie M, Brandon Z, Simpkins S, Ballas S K. Non-pharmacologic management of sickle cell pain. Hematology. 9(3): 235-7 (2004 June).

Nonetheless, current therapies are ineffective at relieving paid in all individuals presenting. For additional discussion of pain therapy, see:
Han S C, Harrison P. “Myofascial pain syndrome and trigger-point management.” Req. Anesth.;22(1):89-101 (1997 January-February).
Janssens L A. “Trigger point therapy.” Probl Vet Med. 4(1):117-24 (1992 March).

Massage techniques such as deep tissue massage or effleurage have a rich variety of effects, for instance, they loosen muscle fibers bound by scar tissue, improve overall muscle flexibility, clear any oedema collected and restore good nutrition to the muscle via an improved blood supply.

Utilization of massage during treatment for pain is increasingly available as a therapy complementary to conventional nursing practice. Clinical experience has demonstrated that myofascial trigger-point massage therapy produced a significant decrease in heart rate, systolic blood pressure, and diastolic blood pressure, in a cohort of 30 clinical patients. In addition the patients exhibited an improvement in muscle tension and emotional state, showed significant improvement. For a more extensive discussion, see:
Delaney J P, et al. “The short-term effects of myofascial trigger point massage therapy on cardiac autonomic tone in healthy subjects.” J. Adv. Nurs., 37(4):364-71 (2002).

Frictions can be used for later stage treatment when multiple cross-linkages between collagen fibers results in considerable stiffness or scar tissue. Frictions are performed transversely across the top of the tissue, with some compressive force, for some minutes at a time. Initially pain levels will be quite high, but as the friction progresses it eases off. For a more extensive discussion, see:
Formby & Mellion. “Identifying and Treating Myofascial Pain Syndrome.” Physician & Sports Med Vol 25 No 2 (1997).
Manheim C, ‘The Myofascial Release Manual’, 2nd Ed. (1994)

Local soft tissue dysfunction has a significant relationship to pain and more general musculoskeletal dysfunction. Neuromuscular Techniques offer an efficient and proven method of soft tissue manipulation. They can be used to assess and treat myofascial dysfunction, to improve general function, to release muscular tension, to assist in the elimination of trigger points activity and to treat and normalize hypertonicity and/or fibrotic changes.

Myofascial trigger-point massage therapy could be especially relevant to the para medical profession, and is a complementary therapy to conventional practice. In normal healthy subjects, myofascial trigger-point massage to the head, neck and shoulder areas is effective in increasing cardiac parasympathetic activity and in improving relaxation.

### BRIEF SUMMARY OF THE INVENTION

The invention is embodied in a new method of delivering massage therapy to the body of a patient wherein pressure is applied continuously and to a profound extent, such that pain is relieved, circulation and movement of the body are improved, and various other benefits of massage are enhanced. The invention is also embodied in a device for applying pressure to an animal body at predetermined pressure points, comprising an elongated pylon, with more than one attachment points, allowing attachment of a pressure head and a pressure base; at least one pressure base attached to the handle; at least one pressure head attached to the handle; and a component or other means for quantitatively determining the force being applied to the body.

One particular embodiment of the invention is a component to provide feedback to a user of the device of the invention as to the level of pressure being delivered by the device. Such feedback has not been previously disclosed, and allows a user of the system, device and method to reproducibly apply pressure therapy, and to recognize the probable onset of injury to an animal body. Such feedback is particularly useful when a patient is unable to provide feedback, such as when the patient is a working animal, or is insensitive to pain due to illness or injury, for instance.

The device of further comprises a force readout component for remotely monitoring applied pressure while therapy is in progress, with such monitoring being by means available such as pressure meters, a diaphragm pressure gauge, a remote pressure transducer, or electronic transducers. The device is characterized by a pylon that is, for instance hydraulically or spring biased and providing a means of transferring and monitoring pressure. The pylon of the device further may alternatively be characterized by piston compression of a fluid as a means to provide a pressure transducer.

In one embodiment the massage device provides a pressure base with a concave upper surface; a pylon with a hand grip and attachment component; a pressure transducing force readout component; and a component for attaching a pressure head component. A variety of pressure heads are available as part of the invention, including a pressure head characterized by a component for engaging a pressure applicator; an upper flattened surface capable of engaging a hand; and a lower surface formed of resilient material of convex shape.

The invention provides for a method of physical therapy comprising determining a target tissue in need of therapy; selecting a pressure base to provide applied pressure; selecting a pressure head through which to apply pressure; applying a predetermined amount of pressure to a patient; and continuously maintaining the applied pressure for at least one second.

The method for providing physical therapy is further embodied in determining a target tissue in need of therapy; selecting a pressure applicator capable of providing quantitiative feedback as to the applied pressure for providing applied pressure; selecting a pressure delivery component through which to apply pressure delivered by said pressure applicator; applying a predetermined amount of a profound pressure to a patient; and continuously maintaining the applied profound pressure for more than 30 seconds. The method further provides for feedback of the applied pressure is continuously provided by a remote pressure transducer.

The invention is further embodied in a method wherein profound pressure is delivered by a device comprising an elongated pylon, with more than one attachment points; at least one selectable pressure base attached to one attachment point on said pylon; and at least one selectable pressure head attached to one attachment point on said pylon, such that a practitioner is capable of delivering profound pressure one or more of reproducibly, repeatedly and for greater application time than would be practicable without use of said device. The pressure applicator is further embodied in a piston compression of a fluid as a means to provide a pressure transducer between the pressure delivery component and a patient. A further embodiment is a pressure communicating component for delivering pressurized fluid for actuation of said pressure applicator to deliver pressure to the pressure delivery component.

The method is further embodied in a controller device providing one or more of audible, visual, and automatic cues for indication of the delivery of pressure by said device. The method and device of the invention is further embodied in a device whereby the pressure is delivered under the control of the patient.

### BRIEF DESCRIPTION OF THE DRAWINGS

FIG. 1 is a front view of an assembled CPT device;

FIG. 2 is a sectional view of the device in FIG. 1 though section 2-2;

FIG. 3 shows a patient to which pressure is being applied by the device of the invention;

FIG. 4 shows a patient to which pressure is being applied using a CPT device fixed to a solid support and with a remotely reading gauge;

FIG. 5 shows an anterior view of a female body showing the location of positional release points;

FIG. 6 shows a posterior view of a female body pointing to the relative locations of selected myofascial trigger points commonly associated with extension strains;

FIG. 7 shows a CPT device with remote pressure indicating display;

FIG. 8 shows a different embodiment of a CPT device being configured to allow a therapist to secure the pylon to the therapist's forearm and providing an optional handgrip;

FIG. 9 shows a detail view of a therapist holding the hand grip of the device in FIG. 8;

FIG. 10 shows a cross section of an adjustable pressure head, as shown in FIG. 8;

FIG. 11 shows a perspective view of a pressure base with a concave circular pressure plate and a threaded attachment stud;

FIG. 12 shows a cross section of the pressure base shown in FIG. 11;

FIG. 13 shows a perspective view of a pressure base with a convex circular pressure plate and a threaded attachment stud;

FIG. 14 shows a cross section of the pressure base with a convex circular pressure plate and a threaded attachment stud shown in FIG. 13;

FIG. 15 shows a perspective view of pressure base with a generally circular pressure plate and attachment threads;

FIG. 16 shows a cross section of the pressure base shown in FIG. 15;

FIG. 17 shows a perspective view of a pressure base with ergonomically formed hand holds;

FIG. 18 shows a perspective view of a disk shaped pressure head with five pressure tips;

FIG. 19 shows a perspective view of a pressure head with a single pressure tip and a central cavity

FIG. 20 shows a perspective view of a pressure head with a linear arrangement of spaced apart pressure tips;

FIG. 21 shows a perspective view of a pressure head with four spaced apart, linearly disposed pressure fingers of differing shapes affixed to a pressure head body;

FIG. 22 shows a perspective view of a pressure head body supporting two spaced apart, linearly shaped, pressure tips or bars;

FIG. 23 shows a perspective view of a pressure head body with two spaced apart, linearly shaped pressure bars and with a tendon bar occupying some of the bar gap space;

FIG. 24 shows a perspective view of a variation of a pressure head which is constructed as a patoi structure;

FIG. 25 shows a perspective view of a pressure head body shaped generally like a flattened human hand;

FIG. 26 shows a perspective view of a CPT device able to support a therapist and allow pressure application while allowing use of the hands during massage of the patient;

FIG. 27 shows a perspective view of the region of the pressure head with hands applying force to the hand grips;

FIG. 28 shows a partial cross section of the pressure head region of the CPT device shown in FIG. 26;

FIG. 29 shows an embodiment of the invention wherein the CPT device is attached to a support frame allowing regulated delivery of pressure to a patient;

FIG. 30 shows an anterior view of a male patient with marks on selected relative CPT tissue target locations adapted to response to use of the device and method of the invention; and

FIG. 31 shows a posterior view of a male patient with marks on selected relative CPT tissue target locations adapted to response to use of the device and method of the invention.

### DETAILED DESCRIPTION OF THE INVENTION

The main object of this invention is to provide a device for applying a non-invasive therapeutically reproducible pressure massage, as effortlessly as reasonably possible, to the skin and underlying tissue. The CPT device and its accessories are useful for massage therapy of the patient body for a variety of therapeutic purposes.

The basic CPT device can be utilized with a number of accessory components that specialized for applying pressure to a particular tissue of the body of a patient. The accessory devices disclosed include features that allow the induction of a therapeutically adequate profound pressure with relatively as little effort as possible, thus enabling a therapist to treat a number of treatment targets, and a number of individual patients, without excessive fatigue. Prior to the present invention, even if a deeply seated tissue site were accessible to application of pressure for treatment (for example the deep muscles in a limb), it was not always possible to apply pressure adequately and accurately enough, and for a sufficient duration to achieve therapeutically effective results. Thus, as the disclosure that follows demonstrates, the modular nature of the CPT device allows effective implementation of a variety of massage and physical therapy techniques.

The device of the invention is preferably constructed as an easily manipulated, hand held massaging device. The device is readily adaptable to a number of therapies, and can effectively be used in variety of means for therapeutic care for musculoskeletal system dysfunction. The device and system of the invention can be used in conjunction with a number of different types of massage therapy known to practitioners of physical therapy. Such therapies include Cyriax Techniques, Neuromuscular Techniques (including Myofascial Trigger Point Therapy, Myotherapy, and others), other Soft Tissue Techniques (including Chill-and-stretch Technique, Deep Tissue Release, Ischaemic Compression, Elbow Technique, and others), sports massage, acupressure, Shiatsu, and reflexology. Use of the device of the invention can provide a range of therapeutic benefits to the patient including increased blood flow, reduced muscle tension, an increase in muscle compliance resulting in increased range of joint motion, decreased passive or active stiffness and increased or decreased neural excitability. Changes in parasympathetic activity following massage results in a relaxation response. For one example in myotherapy, the CPT device is used to decrease tension at the base of the skull, in the muscles of the neck, in the back (upper, mid, and lower) in hip, in arms, legs and shoulders.

In addition to utilization of the device for applications of existing forms of massage therapy, in a preferred embodiment, the device can be employed in new method of pressure therapy, and supply a profound pressure to the patient for an extended period of time. The novel Continuous Pressure Technique (CPT), consists in part of “Continuous Pressure Technique Therapy,” (CPT therapy). The continuous pressure applied in CPT therapy can be delivered as “superficial” or “profound” pressure. The invention is embodied in “Profound Continuous Pressure Technique Therapy” (Profound CPT therapy). The devices of the invention can be used to practice Profound CPT therapy and can be used in the prevention, evaluation, and therapy for alleviation of a wide variety of locomotor diseases.

The CPT therapy can be implemented by applying continuous pressure using one finger, a few fingers, the ball of the hand, the elbow or using specialized devices such as those disclosed herein. Through this process, energy is directed through the skin, using progressive pressure, and is distributed to the tissues. The CPT system is readily practiced by employing a specialized device of the invention that allows a therapist to apply a given pressure to specific pressure points, relieving muscle, tendon, bone/tendon/muscle junctions or nerve associated pain. The CPT therapy system device is in certain embodiments identified as a Davkor unit. The system of the invention employs a device that allows a practitioner-therapist to apply a given pressure on muscle, tendon, and bone-muscle-tendon junctions. The CPT therapy delivered by utilization of CPT therapy device of the invention provides a superior technique to apply a quantitative pressure to the skin on a given trigger point, tender point, and or given acupressure points, and to underlying tissues. The method, system and device of the invention, as expounded herein provides for several applications to conditions requiring physical therapy and or massage, including pain, flexibility, stress or tension. The method, system and apparatus of the invention can also be used in reduction of scar tissue; in restoration of flexibility; in reduction of stress or tension; in relieving restricted physical movement; and to improve sports performance and posture.

As a means for applying profound continuous pressure, as practiced in the method of the invention, the CPT device supports the therapist practitioner by multiplying the applied force, allowing the practitioner to induce a given pressure with as little effort as possible. The CPT device allows the application of a reproducible and an adequate, highly-localized, and or a quantitative continuous pressure to essentially any part of the body of the patient. Particularly, the CPT device allows application of therapeutic pressure even to deeply positioned parts of body, where previously available therapies are ineffective because of the inability of a practitioner to apply sufficient pressure, or to sustain the application of pressure because of fatigue.

Through use of the CPT device, a moderate force for applying pressure to the skin may be concentrated on a very small surface area located on the pressure fingers present on the head of the device. Thus a high pressure is obtained with a relatively small force. Without use of the device, a much higher force must be applied in order to deliver the same pressure to deeply seated tissues. The device assists in the application of profound forces when utilizing the muscular effort and body mass of the therapist, in contrast with existing devices that, although they may allow application of pressure, they do not lend themselves to application of sustained pressure to deep-seated tissue targets. Prior to the invention, therapists would have had difficulty in applying sufficient pressure to practice the profound CPT method, and would have had difficulty in sustaining the required pressures for sufficient time to maximize therapeutic benefit.

One aim of the invention is to provide a device that will help the therapist to work with more ease and comfort. The CPT therapy device provides three additional advantages when used in therapy: first the working area of the practitioner is more functional by reducing clutter, and providing readily employable, modular and multifunctional devices; second, provision for positionable pressure bases and hinged and swiveled arms, such as the units shown in FIGS. 2, 4, 7, and 8, allow therapists to use mechanical advantage and their body weight to increase applied pressure to the patients; and third, by employing multiple units, one or more of which may be positionably fixed to a solid support, the therapist can use multiple CPT devices at the same time.

Another useful feature of the CPT device is to assist the therapist in the prevention of locomotor diseases, and in the therapy of locomotor diseases. The CPT device allows evaluation of disease by monitoring pain utilizing a reproducible system (providing for the establishment and or recordation of a patient-specific pain scale). Another advantage of the invention is the treatment of pain disorders with a neurological component, such as headache or other neuralgias by application of a given force to a known acupressure treatment point.

Additional applications of the method, system and device of the invention also include elimination of acute and chronic pains, irregardless of the origin of the pain (for example pain after accidents and injury; pre-surgery conditions involving muscle spasm). The applications sites can be used for one or all of these areas: skin; tendons; bone-tendon-muscle junctions; muscles; nerves; ligaments; bones; joints; and fascia. The method used to induce a relief of pain in patients is based on the use of a deep continuous pressure-application, which is applied to any part of the body

The method, system and device of the invention can be used for pain diagnosis and evaluation. Thus, the device may be used to evaluate and measure the amount of pain tolerated by a patient, and the quantitative data can be used to analyze the evolution of the disease and or progress of therapy in the future visits.

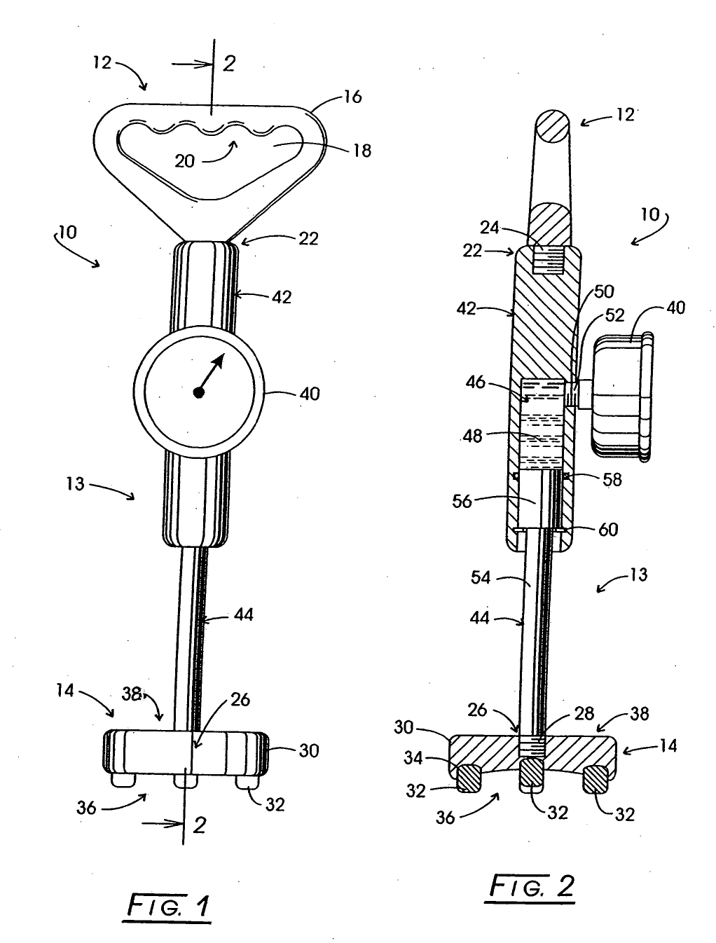

A device suitable for practicing the CPT therapy is shown in FIGS. 1 and 2. FIG. 1 is a front view of an assembled CPT apparatus 10. FIG. 2 is a sectional view of the device in FIG. 1 though section 2-2. The device is composed of three primary components, a pressure base, shown generally at 12, a pylon, shown generally at 13, and a pressure head, shown generally at 14. The pressure base, 12, is shown embodied in a D-shaped grip, 16, with an opening for the fingers of the therapist at 18, and a portion of the grip formed with ridges, shown generally at 20. Such ridges or other means may assist the therapists in maintaining the position of their hand on the pressure base when pressure is applied to the pressure base. Pressure base 16 is shown to threadably engage an internally threaded cavity, positioned generally at 22, by threaded shaft 24, formed as part of base 16. Those skilled in the art will recognize that pressure base 16 can be modified to accommodate other means of engaging the pylon 13, whether by press fit, snap fit, or integral molding or casting, for instance, of the pressure base as part of the pylon. Any of these means would be capable of transferring applied pressure from the pressure base 12 through the pylon 13 to the pressure head 14. The structure of pressure base 12 can take many forms, as will be disclosed below herein.

Pressure head 14 is shown in FIGS. 1 and 2 as being generally disk shaped. Head 14 is constructed with a internally threaded cavity, shown generally at 26, that threadably engages external threads 28 on the end of pylon 13. Just as with the engagement of pressure base 12 to pylon 13, those skilled in the art will recognize pressure head 14 can be modified to accommodate other means of engaging the pylon 13, so long as the means employed are capable of transferring applied pressure through the pylon 13 to the pressure head 14. In the particular embodiment shown in FIGS. 1 and 2, pressure head 14 is formed of two types of components: a disk shaped central platform structure 30, and pressure tips 32, with platform 30 formed with four cavities, 34, that can accommodate the engagement of pressure tips 32. The cavities 34 of pressure head 14 can alternatively be designed to allow pressure tips 32 to removeably engage cavities 34, such that the therapist can utilize the pressure head 14 shown in FIGS. 1 and 2 with any number from zero to four pressure tips 32 engaged in cavity 34. Skilled artisans will recognize that the invention can be practiced utilizing a device that possesses a variety of forms of pressure head 14, including a variety of shapes and numbers of pressure tips. Additional embodiments of the pressure head are discussed below, and additionally in reference to FIGS. 21-24.

Platform 30 of the invention is shown in FIGS. 1 and 2 with a slightly concave lower surface, shown generally at 36, and a flat upper surface 38. A variety of shapes and structures of pressure head 14, specialized for particular applications, are useful in practicing the method of the invention. Certain of the wide variety of possible pressure heads are discussed below herein.

Returning now to pylon 13 of CPT device 10, the pylon is constructed with components allowing attachment or to connect pressure head 14 to pressure base 12. The pylon is adaptable for receiving the other components of the invention. Pylon 13 has a component supplying a means for determining the force being applied to the pressure head 14 by the pressure base 12. In FIGS. 1 and 2, pylon 13 is shown with component 40 a gauge by which the therapist can determine the pressure being applied to the patient through the pressure head 14 while therapy is occurring. No known prior art allows a therapist to instantaneously determine the applied pressure while a patient is undergoing therapy. Pylon 13 embodied as shown in FIG. 1 and 2 is characterizes and comprises a cylinder component 42 and piston-rod component 44. Pylon cylinder component 42 supplies a connection point, as in threaded cavity 22, to the pressure base, shown generally at 12. Pylon cylinder component 42 encloses the pylon cylinder, shown generally at 46, while pylon cylinder 46 contains a fluid 48, such as hydraulic fluid, water, air or other suitable fluid. Pylon cylinder 46 has an outlet port 50, shown in FIG. 2 to threadably engage nipple 52 of gauge 40, allowing communication of the fluid pressure of fluid 48 from the pylon cylinder to the gauge 40. Piston-rod component 44 is composed of rod component 54 and piston component 56. Piston component 56 slidably engages the interior surface of cylinder 46. As embodied in FIG. 2, an O-ring seal, as at 58, is included to ensure that pressure applied to fluid 48 does not leak by piston component 56. Those skilled in the art of pressurized cylinder-piston combinations will recognize a wide variety of means to maintain a seal in a pressurized cylinder, including direct piston-cylinder wall contact, piston rings, and resilient seals applied to the piston. All such combinations are contemplated by the invention.

Thus, in operation, pressure applied to pressure base 12, is transmitted to pylon 13, where the interaction between the pylon cylinder component 42 and pylon piston 56 with fluid 48 transmits applied force to rod component 54, thereby transferring force from the pylon 13 to the pressure head 14. As pressure is applied to fluid 48, the relative applied pressure can be determined by reading gauge 40. If gauge 40 is constructed with a means provided for adjusting the gauge reading to compensate for the surface area through which pressure is delivered to the patient, actual force applied to the tissue of the patient through pressure head 14 and or pressure tips 32 can be determined by reading gauge 40.

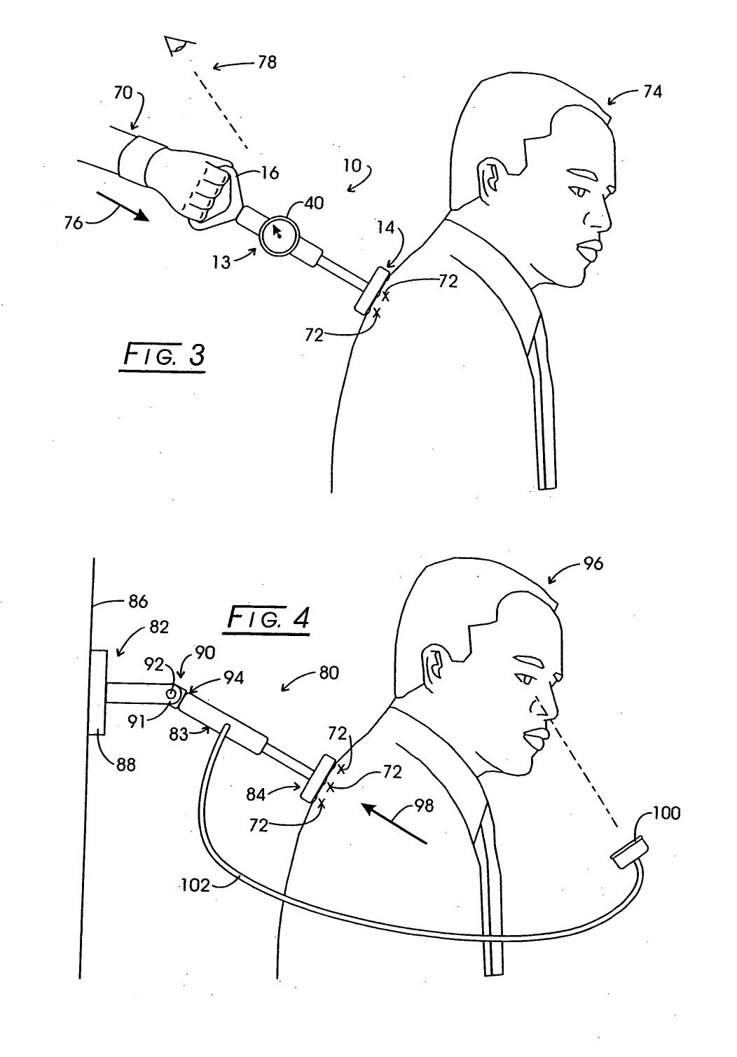

Turning now to FIGS. 3 and 4, FIG. 3 shows a patient to which pressure is being applied by the device of the invention. FIG. 4 shows a patient to which pressure is being applied using a device of the invention fixed to a solid support and with a remotely reading gauge. Referring to FIG. 3, to utilize the CPT device to perform CPT therapy, a therapist practitioner grasps with his hand 70 the grip of handle 16 as part of CPT device 10. Pressure head 14 is positioned at pressure points 72 chosen by the therapist on patient 74. As force, denoted by arrow 76, is applied by the therapist to pressure base 12, such force is transmitted through the pylon 13 to pressure head 14. The mass or muscle force of the patient 74 resists the force applied by the therapist to the CPT device. The therapist can determine the force being applied by line of sight monitoring, as at 78, of the pressure reading of gauge 40.

Referring to FIG. 4, a different embodiment of a CPT device is shown at 80. In FIG. 4, pressure base 82 is attached to a fixed support 86 using mount 88. Pressure base 82 engages pylon 83 by means of a moveable pivot 90 about hinge 91 and hinge pin 92. In this particular embodiment a swivel 94 is included as part of the pylon 83 to allow a wider range of motion for the device. Such components such as pivot 90 and swivel 94 would not be necessary for all applications of the invention, nor for all devices that are attached to a solid support. By fixing pressure base 82 to a solid support with mount 88, the patient is enabled to perform CPT therapy without direct assistance from a therapist practitioner, and could utilize the CPT therapy outside the therapist's clinic. Patient 96 positions pressure head 84 so that pressure may be applied to one or more pressure points 72. Pivot 90 and swivel 94 allow patient 96 a wide range of positions through which to apply pressure to one or more pressure points 72. Depending on the mounting location of mount 88, the patient 96 can deliver pressure to many locations on the body of the patient. The CPT device 80 could be mounted to enable application of pressure to the anterior or posterior surfaces of patient 96, whether the patient is in a standing, sitting, or reclining position. The CPT device could be mounted to a ceiling, floor, or furniture, so long as movement of the mount was restricted from moving when pressure was applied to the tissue of a patient. Moreover, pressure base 82 could be attached to an extended arm that provides additional swivels, pivots or positioning means.

As embodied in FIG. 4, the patient 96 supplies the force 98 necessary to deliver pressure to pressure points 72 through muscle effort, the effect of body mass, or the such. As shown in FIG. 4, force is being applied to pressure points on the posterior surfaces of the patient 96. In order for patient 96 to monitor the applied force, remote gauge 100, a force readout component of the invention is connected to the pylon cylinder component by an extended pressure communicating component 102. Pressure communicating component 102 could be embodied as a pressurized tube containing fluid 48, or alternatively could be a wire connecting a pressure transducer in communication with the pylon cylinder component connected to a wired digital pressure indicating gauge. The pressure readout can be accomplished by a variety of means, including digital, analog, aural, or any other means perceptible by one employing the apparatus of the invention. The connection between pressure transducing component and the force readout component can be accomplished by a diverse variety of methods available for associating the transducer and readout components. The remote readout capability of gauge 100 allows the patient 96 to monitor applied pressure indicated by gauge 100, even when the patient is not in direct sight communication with CPT device 80. Similarly, device 10 is also embodied with a CPT device that includes a remotely reading gauge such as gauge 100. Using a remote reading CPT device such as device 80, a therapist practitioner could utilize CPT therapy on a patient in an orientation that limits the view of a gauge as arranged in device 10 of FIG. 1, and continue to monitor the pressure applied to the patient. In other embodiments of the invention, the face of gauge 40 or 100 or the like, can be arranged to point in a direction that improves the ability of a practitioner therapist to monitor applied pressure while said pressure is being applied.

In one of the advantages of the invention, existing massage devices with fingers are believed to lack the means to monitor applied pressure, and the means to enable a therapist to accurately deliver a profound force to precise pressure points. Certain acupressure devices present in the art do provide a rudimentary means to provide a pressure reading. See for example the device disclosed in U.S. Pat. No. 3,706,309 to I. N. Toftness, issued Dec. 19, 1972. A wide variety of pressure delivery heads are available, but these devices are not well suited to use with the CPT therapy because they are not adapted to deliver profound pressure, and therapists using the prior art pressure devices are prone to fatigue and injury. As one example, the device as shown in U.S. Pat. No. 5,817,037 to Zurbay, issued Oct. 6, 1998, does not readily allow the therapist to continue applying pressure to chosen pressure points, without difficulty or fatigue. Devices such as that of Toftness and Zurbay, would in no way allow a patient to apply a particular amount of pressure to their own back, as viewing the scale on the side of the device would be completely impractical, if it were not impossible.

The CPT device invention ideally possesses a pressure transducing component. Gauge 40 in FIG. 1 and 2 is in direct communication with fluid 48, and in one embodiment is a diaphragm type gauge, whereby the fluid pressure of fluid 48 causes displacement of a diaphragm and such displacement is transduced to a movement of the needle of gauge 40. A pressure transducer suitable for use with the invention could also function by electronically detecting pressure differences. Many types of pressure transducers, in addition to mechanical displacement types of gauges are known in the art.

Recognizing that an important feature of the invention is a means to transduce applied pressure into a readily ascertainable reading, other structures can be employed in constructing the pylon to accomplish the same goals, and produce a device useful for implementing CPT therapy. The invention can be practiced with a pylon that substitutes for the fluid 48 and fluid pressure gauge 40 a spring biasing system, that transduces the compression of a spring positioned in the pylon structure located generally at 46 to a mechanical gauge or mechanical electric gauge located similarly to gauge 40.

It should be apparent that fluid 48 can function with a number of different embodiments of fluids, so long as said fluids behave general according to the physical laws describing fluids. For instance, as mentioned previously and elsewhere herein, fluid 48 can be a relatively incompressible substance such as hydraulic fluid, oil, water, or other liquid with properties that are adaptable to the CPT device. Moreover, said fluid 48 can be comprised in whole or in part of a gas, such as air; inert gases such as, for instance, nitrogen or noble gases, gas-liquid equilibria. Different fluids may be adaptable to particular applications wherein the compressibility of the fluid is important, the availability of sufficient volumes of said fluid to utilize the device economically, and the ability to limit or propagate pressures exerted on the body of the patient by the CPT device.

As shown in FIG. 4, when the pressure base attached to a fixed support, the ability to apply CPT therapy to the entire body of the patient may be limited by the fixed position of the pressure base.

As mentioned previously, the device and method of the invention can readily be employed in existing trigger point, positional release, and acupressure therapies. However, the aforementioned techniques are particularly suited for and concentrated primarily on alleviation of pain associated with myofascial trigger points, (i.e. referred muscle pain). However, the present invention allows treatment of pain arising from a wide variety of tissues. Turning to FIGS. 5 and 6, an illustration of the location of positional release points or myofascial trigger points described in the art are shown. FIG. 5 is an anterior view of a female body showing the location of positional release points identified by Jones, as described in Cannon, 2002. The following release points commonly associated with flexion strains are shown: squamosal, 120; supra-orbital nerve, 121; anterior acromio-clavicular, 122; infra-orbital nerve, 123; latissimus dorsi, 124; anterior 7th cervical, 125; anterior 7th thoracic, 126; depressed upper ribs, 127; anterior 8th thoracic, 128; radial head, 129; anterior 9th thoracic, 130; iliacus, 131; medial coronoid, 132; thumb and fingers, 133; anterior 2nd lumbar, 134; medial patella, 135; lateral meniscus, 136; lateral hamstrings, 137; medial ankle, 138; flexion strain of ankle, 139. FIG. 6 shows the relative locations of myofascial trigger points on the posterior body surface, that are commonly associated with extension strains: sphenobasilar, 150; right lambdoid, 151; inion, 152; intervertebral tension dysfunction, 153; posterior acromio-clavicular, 154; upper lumbars, 155; lateral olecrenon, 156; upper pole 5th lumbar, 157; posterior lateral trochanter, 158; high flare out sacro-iliac, 159; posterior medial trochanter, 160, 161; antrerior cruciate ligament strain, 162; gastocnemius, 163; posterior cruciate ligament strain, 164; lateral ankle strain, 165. The identified myofascial tender points or trigger points in FIGS. 5-6 are believed to be bilateral in response to a specific strain, but are shown in FIGS. 5-6 only on one side of the body for the sake of clarity. The particular locations also are relative, and may vary within a particular area between patients, and with respect to the particular trauma causing referred pain. Not all of known points are identified, as different locations are widely published in the art. The images of FIGS. 5-6 are displayed on the body of a woman, but practitioners will recognize that release points and or trigger points also occur on the body of a human male, with many, but not all of these locations being expected to occur in the same relative locations in either sex.

The therapist utilizing the system and method chooses an appropriate pressure head and positions the pressure tip or finger of the pressure head against the appropriate pressure point on a patient. The therapist applies pressure to the pressure base, typically by placing the base against the body of the therapist and leaning on the pressure base. Pressure applied by the therapist is transmitted through the pylon to the tip/fingers of pressure head. Position of the pressure tips or fingers can be controlled by the therapist's hand on pylon grip. The level of pressure applied is monitored by the pressure meter, or by other means, such as by the experience of the therapist, or by the onset of severe pain in the patient. The therapist is enabled by the CPT device to deliver pressure to target areas of the patient with greater total pressure, for a longer duration and with greater reproducibility than is possible by a therapist utilizing only his/her own fingers. Referring again to FIGS. 3 and 4, the therapist-practitioner, if providing therapy for another, or the patient, if providing self-help therapy, locates a tissue position in need of therapy, for instance one of the points identified above, and in FIGS. 5 and 6, whether through palpation ability, training, and or extensive clinical experience. The pressure head (14 in FIG. 3), and the pressure fingers, 72, are applied to the chosen location. Pressure is then applied to the pressure base, with the applied pressure being transmitted through the pylon component to the pressure head, pressure fingers, and thus to the tissue position targeted for pressure therapy. With the devices shown in FIGS. 3 and 4, the applied pressure is measured with pressure gauge 40 or remote pressure indicator 100. The therapist starts the pressure therapy and then adjusts the force applied to the apparatus according to the reading of the gauge and to the pain of patient. When practicing the method of the invention, pressure is maintained upon the tissue position for an extended period of time, such that relief from pain or other therapeutic benefit is obtained. Thus, awareness of the pressure and or force being applied to the tissue target enables the best therapeutic efficacy to be realized for the treatment period.

In addition to treating Myofascial Pain Syndrome, the device of the invention is useful for a number of therapy applications, including tendinopathy, bursitis. neck pain, migraines, headaches, Temporomandibular Joint Dysfunction (TMJ Syndrome), back pain, chronic pain, lumbago, sciatica, scoliosis and other spine disorders, Carpal Tunnel (wrist pain), arthrosis, sports injuries, repetitive strain injuries, sprains/strains/athletic injuries, chronic stress and/or tension, relaxation, relief of pain/spasm, fibromyalgia, Chronic Fatigue Syndrome, hypomotility, motion restriction, joint fixation, acute joint locking, motion loss with somatic dysfunction, somatic dysfunction, relaxation of muscles, postural disorders/muscle rehabilitation, lymphatic drainage, and improvement in circulation. As the list of therapy applications shows, the particular pain centers associated with positional release techniques and Myofascial Pain Syndrome represent only a subset of tissue targets to which pressure may be applied to achieve therapeutic benefit through use of the system method and devices of the invention. Those skilled in the art of use of musculoskeletal therapy devices will recognize applications of the system and apparatus of the invention for a variety of treatment modalities. Certain specific descriptions of the particular treatment regimens contemplated are disclosed in the Examples section below.

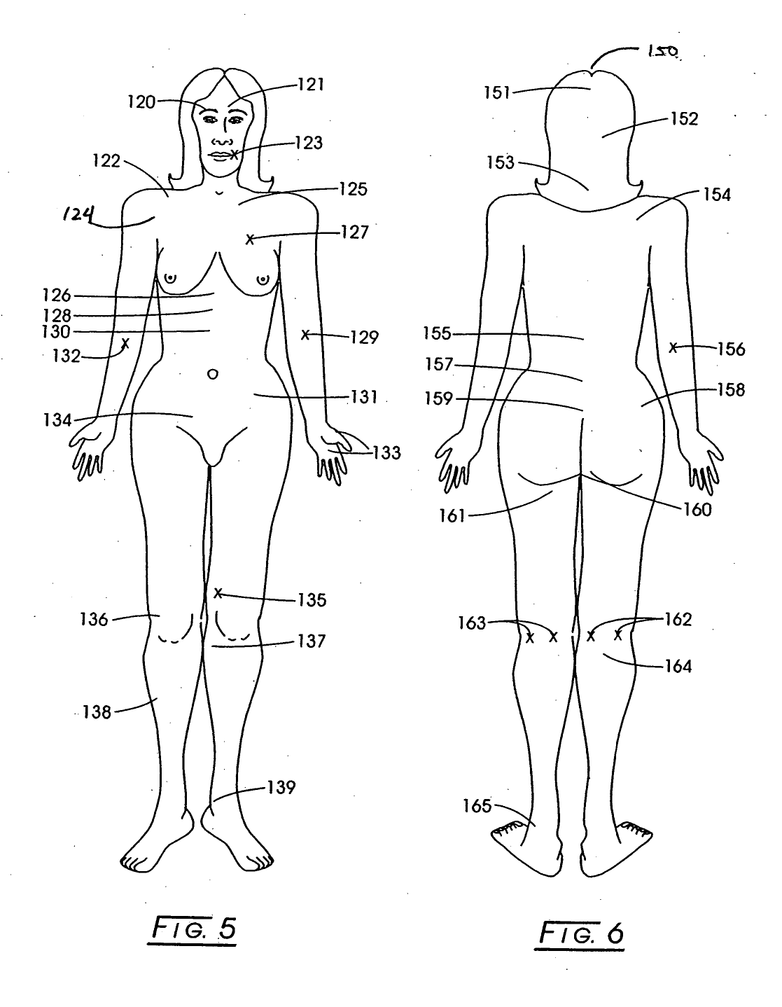

Those skilled in the art of device construction will recognize that the construction of the CPT device and accessories are not limited to specific mechanical or electronic systems, so long as the features of the invention are accomplished. Another embodiment of the invention and a device with remote pressure indicating display is shown in FIG. 7. FIG. 7 is a sectional view of a transponding CPT device 170 that possesses a modular pressure base 172, a transponding pylon 173, and a modular pressure head 174. The pressure base, 172, is shown embodied in FIG. 7 with a hinge component 176. Hinge component 176 connects stem 178 and plate 180 to pylon 173, allowing respositioning of plate 180 along a wide arc about hinge component 176. Pressure base 172 is shown to threadably engage an internally threaded cavity, positioned generally at 182, by threaded shaft 184, formed as part of hinge component 176. A swivel could also be included in hinge component 176, or pressure base 172 could rotate about the threaded shaft 184. Thus, pressure base 172 can be positioned in nearly any orientation about the top end of pylon 173, allowing the therapist great flexibility in positioning the device for delivery of pressure. Pressure head 174 is shown in FIG. 7 as being generally disk shaped, with an internally threaded cavity 186, that threadably engages external threads 188 on the end of pylon 173. Pressure head 174 is shown with a disk shaped platform 190, and two pressure tips 192.

Referring now to pylon 173 of CPT device 170, shown in FIG. 7, the pylon has pressure transponder 200 that provides a means for determining the force being applied to the pressure head 174 through the pressure base 172. Pylon 173 as shown in FIG. 7 is composed of a cylinder component 202 and piston-rod component 204. Pylon cylinder 206 contains a fluid 208, allowing communication of the fluid pressure of fluid 208 from the pylon cylinder to the pressure transponder 200. Thus, in operation, pressure applied to pressure base 172, is transmitted to pylon 173, where the interaction between the pylon cylinder component 202 and pylon piston 206 with fluid 208 transmitting applied force from the pylon 173 to the pressure head 174.

As pressure is applied to fluid 208, the relative applied pressure can be transponded as at 210 to remote pressure integrator 212 by pressure transponder 200. Pressure transponding as at 210 can be achieved by means of a wireless transmitter, as shown, by a wired connection, or by means of a physical connection to fluid 208. A wireless receiver, integrating circuitry, and controls are contained within case 214. Remote pressure integrator 212 may be constructed with an adjusting dial 218 providing a means for adjusting the indicator reading to compensate for the surface area of pressure tips 192, for instance, and such surface area can be indicated on meter 216 by depressing non-latching or spring switch 220. As a safety feature, LED 226 lights only when an pressure head surface area has been indicated since the last use of the CPT device, avoiding false pressure indications following exchange of pressure heads. Remote indicator 212 also may be constructed with adjusting dial 222, that can be used to set pressure limits, most typically an over-limit indication. Depression of non-latching or spring switch 224 displays the pressure limit setting on meter 216. LED 228 blinks when applied pressure nears the preset pressure limit, and continuously lights when the pressure limit is reached. An audible indicator of an over-limit condition may also be linked to the remote pressure integrator 212. Thus, inclusion of adjustment modalities for the device allows for the device to be programmed to apply different levels of pressure based on the professional's assessments of patient needs.

The exposition now turns to a detailed description in turn of the components of the CPT device beginning first with a more complete description of the modalities of the pylon component, turning then to the pressure base component and finally the variations of the pressure head component The pylon component of the invention can be embodied in a number of forms, as has been shown. Returning briefly to FIGS. 1 and 2, the pylon component is preferably embodied as a cylinder and a piston, as shown at 13 in FIGS. 1 and 2. The length of the pylon component is preferably for about the 5 cm to about to 120 cm in length. The cross section of the pylon component may be circular, elliptical, rectangular, square, or hexagonal, for example. The outside diameter of the pylon component is preferably from about 1 cm to 20 cm and more preferably from about 2 cm to 10 cm. The outside diameter of the pylon component is expected to be at least 0.5 cm, whatever the form of the pylon, in order to provide sufficient structural support to avoid structural failure of the pylon component during use of the device. Although shown at 10 in FIG. 2 with a piston 56, sealing ring 58 and fluid 48, the compression of the piston can be actuated with different mechanisms that allow the accomplishment of pressure delivery along with a means of measuring and transponding the delivered pressure. Thus, piston-rod component 44 and piston cylinder component 42 can also be embodied in an arrangement employing spring biasing, or a system actuated by a fluid, air, or hydraulic pump or compressor or by means of an electrical gear or screw drive system, and or by means of an electrical or air-pressured hammer type device.

The pylon component is also embodied in other structures that accomplish the goal of effective pressure transmission. Though shown in FIGS. 1, 4 and 7 with a predominantly cylindrical structure, the pylon component can have many shapes for specific use, whether cylindrical, linear, with accommodation for attachment of head or base at an angle, or with the outer walls of the pylon curved, such as a pylon with a concave section.

In typical operation, when the CPT device is used with a component for pressure indication of applied pressure, the device will be operated with pressure applied only to the pressure base. Although pressure may be applied only to the pressure base, for certain applications, increased control of the pressure head position is desired. CPT device 250, as shown in FIG. 8, is specially configured to allow a therapist to secure the pylon to the therapist's forearm, providing enhanced control of the pressure application and allowing use of the upper arm to apply pressure. The device 250 possesses a pressure base 252, an ergonomic pylon 253, and an adjustable linear pressure head 254. A means for attaching the pressure base 252 is provided at 258. Pressure base curved plate 260 is configured with a concave upper surface that is provided in a size that allows the concavity to fit around the upper arm of the therapist. The pylon cylinder component is shown at 262, as the pylon rod component is shown at 264. Pylon handle 266 ensheathes the pylon cylinder component and preferably is constructed of resilient material. Pylon handle straps 268 are attached to either the pylon cylinder directly, or as shown to the pylon handle 266. Preferably pylon straps are equipped with hook-loop fasteners, buckles, or snaps. Pylon rod component 264 is configured with an ergonomically formed hand grip 270, preferably formed of resilient material, and hand grip 270 may either be bonded in position on rod 264, or slide along rod 264. When hand grip 270 is not bonded to rod 264, the pressure that can be applied with the therapist's engaged hand is limited, and the reading of applied pressure provided by the pressure transponder 278 will have greater accuracy. In order to utilize the pressure base, handle and grip provided by CPT device 250, as shown in FIG. 9, the practitioner grasps the ergonomic hand grip 270 with his hand 272. The therapist's forearm will lie along the pylon handle 266 (of FIG. 8), and the forearm may be removeably fixed to the pylon handle by means of pylon handle straps 268. Concavely curved pressure base plate 260 will then fit around the upper arm of the therapist, relatively near the elbow. Thusly positioned, the therapist is able to carefully place and guide the pressure head into a chosen position, and can subsequently apply significant force by use of the therapist's strong muscles of the upper arm and shoulder. Moreover, if additional pressure is desired a therapist is able to provide additional force by leaning on the pressure base plate, thus utilizing the advantage of the therapist's body mass.

As is clear from the preceding description, the structure of the pylon system can take a variety of forms. Additional forms may also include optional pylon extension components which are attached between the pressure base and the pylon in order to extend the length of the device or to allow use of the device in other orientations.

In one embodiment of the invention, the modular system of the invention could be constructed to include a modular pressure base, pylon, and modular pressure head, with the pylon being constructed without a gauge or pressure transponding means. In this instance, other indicators of applied pressure, such as pain experienced by the patient, or experience of the therapist could partially substitute for the feedback typically provided by a pressure reporting gauge. Thus the method of the invention of continuous pressure therapy could be practiced, in a more rudimentary, and less objective manner, without inclusion of a pressure reporting component. The preceding embodiments of the pylon component of the CPT therapy system provide for a therapy device specialized for use in delivery of profound continuous pressure, according to the method of the invention. In other applications, such specialized attachments are not necessary, or desired. Thus, particular components of the pylon system can be simplified or eliminated in order to effectively utilize other components of the system, for instance pressure heads, in existing therapy systems. In particular, a simplified pylon component can be utilized that merely connects the modular pressure bases of the invention to the modular pressure heads of the invention, allowing use of pressure heads without the feedback provided by the pressure transponding components or pressure gauges.

Turning now to a more complete description of the pressure base of the invention, it should first be emphasized that in a preferred embodiment, the therapist's body acts as the primary source of force necessary to practice the method and system of the invention. A therapist's body is preferably used to apply force to and support for the pressure base thus applying pressure to the affected area on the patient that is to be treated. The pressure base can be held against the body and force applied by the following body parts: the hand, the elbow, the junction of arm and shoulder, including the underarm regions, the chest, abdomen, hips, pubic area, inferior legs and superior legs. Although use of other parts of the body to apply pressure is possible, for instance the foot, most therapists are insufficiently nimble to apply pressure to a patient with other body parts and retain sufficient control for effective therapy. It should be recognized that with pressure bases affixed to a support (see FIG. 4), pressure can be applied with other body parts, such as the back, head or bottom of the foot.

As previously described, pressure base 12 of FIGS. 1, and 2 is adapted particularly for applying pressure with the hand, by gripping hand grip 16. Pressure base 12 is also well-suited for diagnostic procedures, allowing a determination of the patient's pain threshold, by careful placement and excellent control of the force applied to a tender point. Demonstrating the modular nature of the system of the invention, hand grip pressure base 12 can be attached to a variety of pylon configurations, including those of pylon 80, shown in FIG. 4, and pylon 170 of FIG. 7. The combination of pressure base 12 and pylon 170 along with a remote pressure integrator for use in a diagnostic procedure provides a therapist an opportunity to determine objectively the amount of pain the patient can tolerate, and such data can be manually or automatically recorded to track the progress of therapy for use in evaluation of a patient and a patient's ability to return from disability leave, for instance. As shown in FIG. 4 pressure base 82 can be attached to a convenient fixed support, and further be provided with an adjustment means, such as hinge 90 and swivel 94. FIG. 7 shows hinged pressure base 172, with a detachable pressure plate 180, with a convex surface. Plate 180 can easily rest in a concave surface of the therapist's body, such as the sternum, the armpit, the abdomen and the pubic region. As those skilled in the art will recognize plate 180 can be made in a range of sizes to fit different therapist's and different anatomical regions in a optimal manner. The adjustable orientation aspect of hinged pressure base 172 to allows a therapist to position the pressure base for improved mechanical advantage, and optimal force application. For instance the practitioner can position the pressure base plate 180 on the sternum, and while leaning over a reclining patient, adjust the angle aspect of hinge 176 in order to maintain applied pressure from a standing position. As described in connection with FIGS. 8 and 9 pressure base 252 is especially effective when strapped to the arm of a therapist. The therapist's arm rests in the concavity of pressure plate 260 and may be secured with optional belts 268 (as part of the pylon component) tightened around the forearm to provide improved control over the assembled CPT device. Such an arrangement may also magnify the available force to be applied to the tissues of the patient.

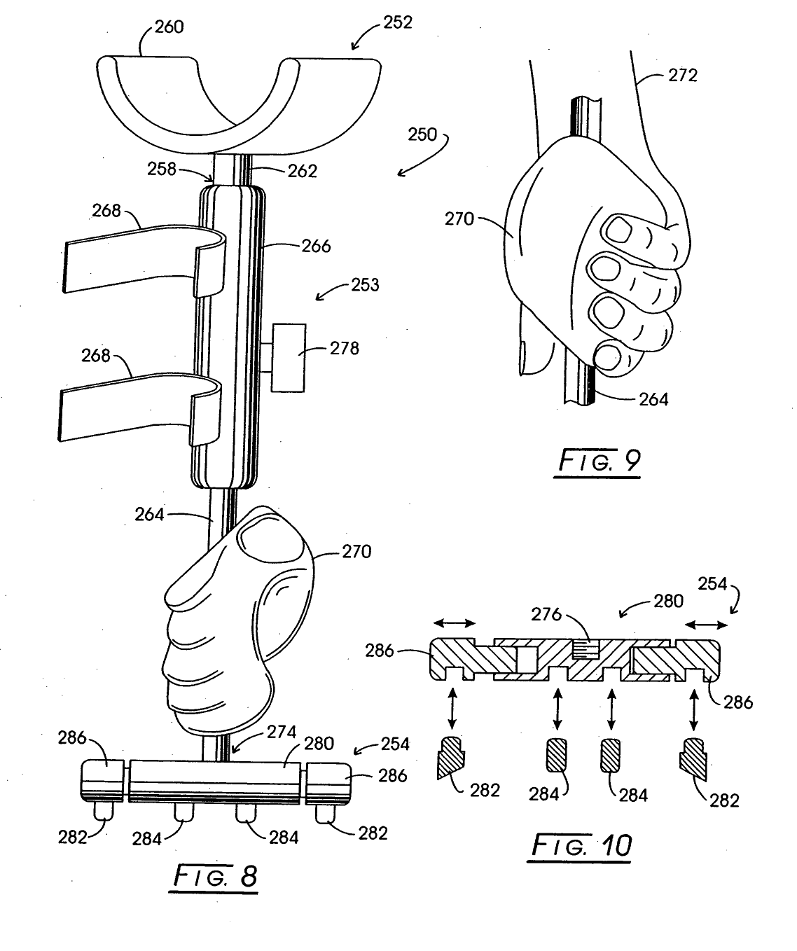

A pressure base shaped as plate 260 of FIG. 8, but of a larger size is useful as a shoulder and or underarm pressure base. FIGS. 11-17 show perspective and cross-sectional views of a variety of pressure bases. Again it should be noted that these bases are constructed in a number of sizes, and sized to fit various anatomical parts and individual therapists. FIGS. 11 and 12 show a pressure base 302 with a concave circular pressure plate 310 and a threaded attachment stud 311. Larger concave bases may be used with superior or inferior legs. A concave base such as base 302 is also useful for applying pressure by positioning the base on convex surfaces of the chest, abdomen, hips, pubic area, and inferior legs. FIGS. 13 and 14 show a pressure base 312 with a convex circular pressure plate 313 and a threaded attachment stud 314. Larger convex bases base such as base 312 are useful for applying pressure by positioning the base on concave surfaces of the chest, abdomen, hips, pubic area, and legs.

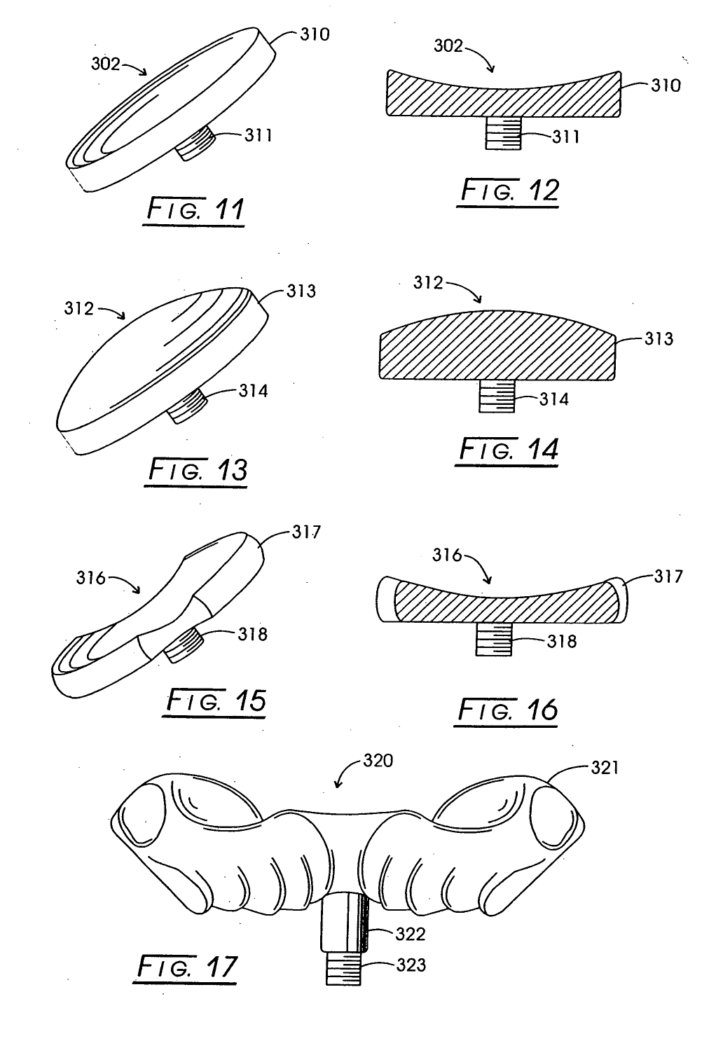

Pressure base 316, shown in FIGS. 15 and 16, has a generally circular pressure plate 317 and attachment threads 318. Pressure base 316 possesses ergonomic features that allow greater flexibility for placement of the base on the body of the physical therapist. Looking closely to pressure plate 317, it is seen that the circular shape is interrupted by the removal of an elliptical portion of the circular plate on two opposing sides of the plate. Plate 317 thus fits comfortably where a similar sized pressure plate, of a full circle, would be uncomfortable to the practitioner, for instance the shoulder, pectoral region, or pubic region. A concavely shaped ergonomic pressure plate can be constructed by the removal of an elliptical segment from opposing sides of pressure plate 313 of FIGS. 13 and 14. Finally, FIG. 17 shows a pressure base 320 with ergonomically formed hand-holds 321 (shown to accommodate two hands), as can be formed of resilient material over a structural support. Shaft 322 is firmly attached to the structural support of handholds 321, and is provided with an attachment means as threaded portion 323. A similar pressure base is constructed to accommodate one hand.

The pressure base preferably supports one pylon, but in certain instances (for instance a fixed support) may support two or three or more pylons. A double base attached to a single pylon may also be used to increase the comfort of the therapist and also to increase the force applied on the patient. The pressure plate portion of the base may have different shapes such as for example circular, elliptical, square, or hexagonal. The base can be equipped with a belt or straps, such as the pylon handle straps 268 of FIG. 8, in order to maintain the position of the base on the body of the therapist, thus allowing the therapist's hands to remain available to position the head on the patient's body.

Turning finally to a more complete description of the pressure head of the invention, it should first be apparent that the pressure head of the CPT device is the point of contact in the application of pressure to the area of the patient's body affected by disease or injury. Thus, the pressure heads of the system are adapted to the size and anatomy of the body part being treated. Referring briefly to FIGS. 1 and 2, is shown pressure head 14, as being generally disk shaped. Such a disk shape is a preferred embodiment of the pressure head configuration, as it allows a variety of pressure tips or pressure fingers to be installed. The size of platform 30 can be altered to accommodate more or fewer pressure tips 32 to be installed, and to better fit the anatomical location being treated. Platform 30 is shown with four cavities, 34, that can accommodate the engagement of zero to four pressure tips 32. Turning to FIG. 7, pressure head 170 is shown in cross section as a flat disk platform 190, with two pressure tips 192. Turning further to FIG. 18, a disk shaped pressure head 340 with five pressure tips 344 is shown. Head 340 is constructed to also comprise platform 342 and pylon attachment means 346, allowing attachment and removal of head 340 to a system pylon. Pressure head 340 has an arrangement of pressure tips that is useful for application to the posterior of the skull of a patient, for instance in the treatment of tension headaches or migraine headaches. As should be clear, similar pressure heads can be constructed with a variety of pressure tip sizes and pressure tips numbering from 1 to about 40 or more. In preferred embodiments of disk shaped pressure heads, the platform will support 1, 2, 4, 5 or 14 pressure tips.

There are a variety of shapes of pressure tips that are adapted for particular treatment regimens. Pressure tips 344 of FIG. 18 have a shaft portion 348 and a face portion 350. The face margin 352 of pressure tip 344 is constructed as a sharp transition between shaft 348 and face 350. As shown in FIGS. 1 and 2, pressure tip 32 has a rather blunt tip, with a champfered margin. Such a structure applies force to a concentrated area of tissue and can apply pressure to rather deep seated foci. The champfered margin avoids or minimizes tissue damage and or lacerations or abrasions. More narrow or sharper pressure tips can apply focused pressure that has the potential to apply therapeutic pressure to deep seated tissue targets.

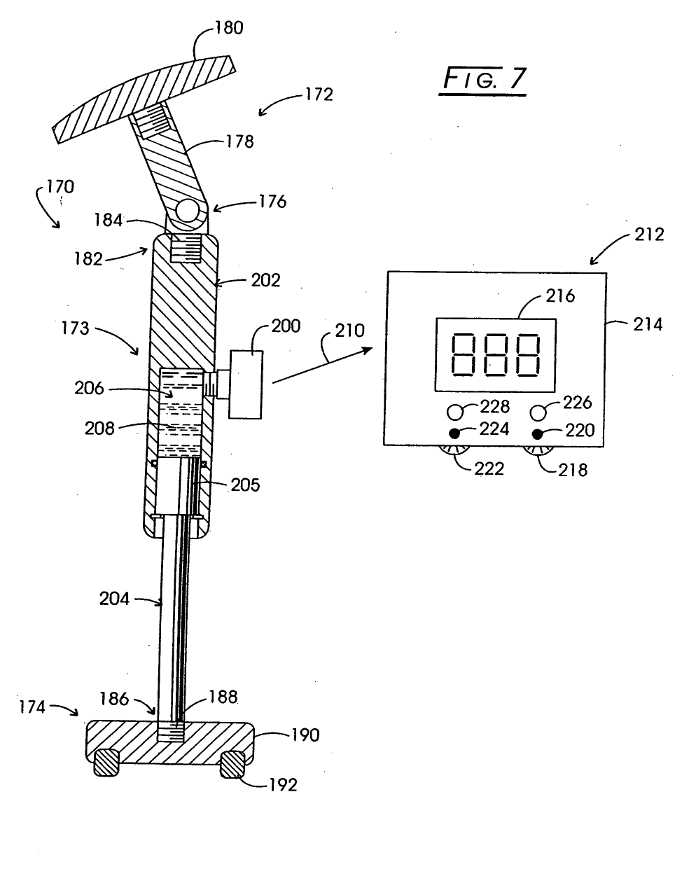

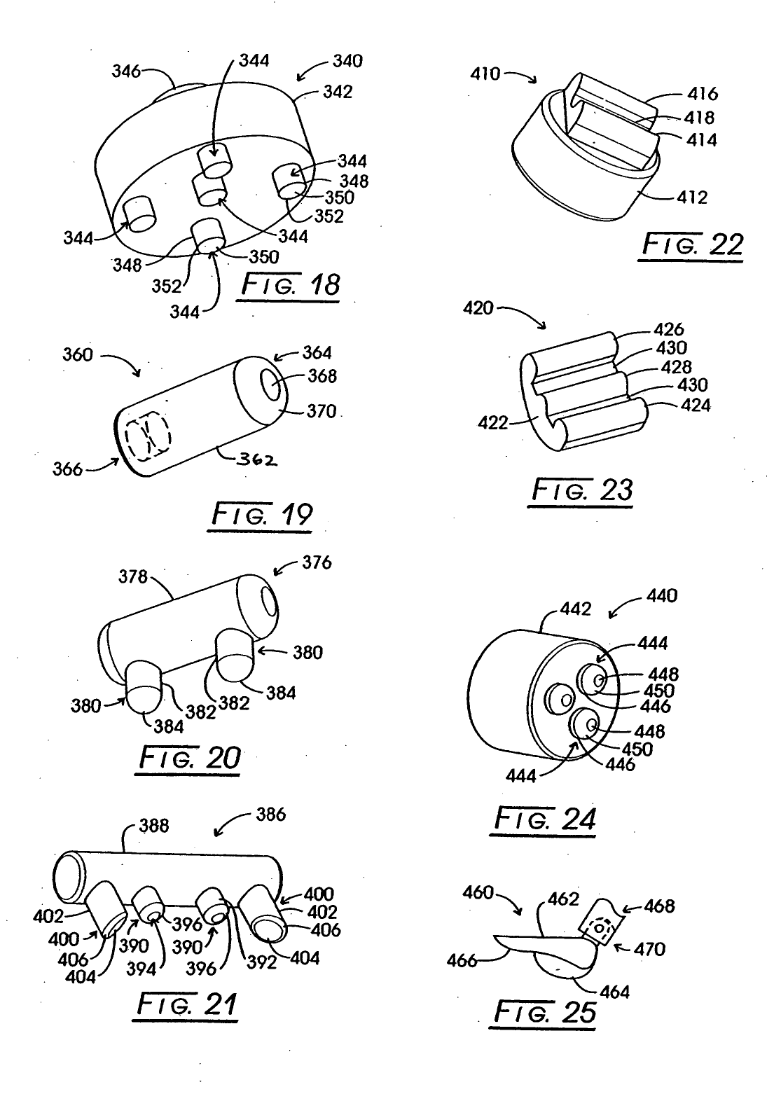

A variation of pressure head is shown in FIG. 19. The pressure head 360 in this embodiment possesses a single pressure tip. Pressure shaft 362 supports pressure face 364, and pylon attachment means 366. Pressure face 364 is formed with a central cavity 368 along with a spherical margin 370. Pressure head 360 is particularly suited for pressure therapy on concave body surfaces or any other part of the body of the patient. Turning now to FIGS. 20 and 21, pressure heads can be formed with a linear arrangement of pressure tips as demonstrated by pressure heads 376 and 386. Pressure head 376 is constructed of pressure head body 378, with affixed pressure fingers 380. Pressure fingers 380 have a finger shaft 382 and a spherical pressure face 384. Similar pressure heads can be formed with 3 or more linearly disposed pressure fingers. Pressure head 386, shown in perspective view in FIG. 21 has four spaced apart, linearly disposed pressure fingers affixed to pressure head body 388. Pressure head 386 is formed with two types of pressure fingers. Pressure fingers 390 are similar to pressure fingers 380, in that they possess a finger shaft 392 and a generally spherical pressure face margin 396, yet the pressure face 394 is flat. The second type of pressure finger on pressure head 386 is angled pressure finger 400. The pressure shaft 402 terminates at an angled pressure face 404 and champfered pressure face margin 406. Pressure face 404 is disposed at an approximately 45 degree angle relative to both the long axis of pressure head body 388 and pressure finger shaft 402. The orientation of the pressure fingers on pressure head 386 mimic the orientation of four fingers of a therapist. Pressure head 386 is adapted for applying pressure across a convex surface, such as perpendicular to the axis of the spine or neck. Returning briefly to FIGS. 8 and 10, an adjustable pressure head 254 is shown. Pressure head body 280 has a pylon attachment component, shown as an internally threaded cavity 276. Similar to pressure head 386, two types of pressure fingers, angled 282 and blunt 284, can be removeably installed in pressure head body 280, as shown a cross-section in FIG. 10. Alternatively identical pressure fingers, such as fingers 282, or less than four fingers could be installed on pressure head body 280. Pressure head body sliders 286 enable the practitioner to adjust the width of the pressure head, as shown in FIG. 10, thus allowing the pressure fingers to be positioned precisely on the treatment target of the patient.

Variations of the pressure head are shown in FIGS. 22-24. Referring to FIG. 22, pressure head 410 is formed with pressure head body 412 supporting two spaced apart, linearly shaped, pressure tips or bars 414 and 416. The size of bars 414 and 416, and the size of bar gap 418 can be varied. Such a pressure head is adapted for application of profound force to the area abutting a tendon, such as the Achilles or hamstring, or to apply force to the attachment point of a tendon or ligament, without applying force to soft or injured tendon tissues. Similarly pressure head 420, shown in FIG. 23 is formed with a body 422, two spaced apart, linearly shaped pressure bars 424 and 426, with tendon bar 428 occupying some of the bar gap space 430. Thus, bars 424 and 426 can apply significant pressure to the tissues abutting a tendon, and a reduced force can be simultaneously applied to the tendon by tendon bar 428. Such a pressure head is also adaptable to other uses. FIG. 24 shows a variation of a pressure head 440 which is constructed as a patoi structure. Pressure head 440 is formed with body 442, and pressure fingers 444. Pressure fingers 444 have a relatively short shaft 446, a hollow pressure finger face 448 and spherical face margins 450. The pressure fingers of pressure head 440 are arranged in a triangular orientation. Such a pressure head is useful for treatment of tendons insertions or muscle fibrosis.

Referring now to FIG. 25, is pressure head 460, shaped generally like a flattened human hand. Body 462 is formed of relatively rigid material, with heel 464 of resilient material affixed to body 462. Body 462 extends to flattened pressure fingers 466. Attachment component 468 is preferably formed with a positionable swivel, pivot, and or hinge, shown generally at 470. Thus pressure head 460, when attached to a suitable pylon and pressure base, can be used as a substitute for the therapist's own hand, relieving the therapist from fatigue and injury, and allowing application of greater pressure than typically could be maintained by an unassisted therapist.

As should be clear, wide variety of pressure heads can be used to practice the invention. The fingers of a particular pressure head can be configured with varying lengths and or profiles. Pressure heads of given finger configuration can be produced in different sizes to accommodate patients with a different anatomy. The pressure fingers of the invention are available to the therapist in different sizes and different shapes, such as a concave, convex, blunt, angled, spherical, blunt spherical and hollow tip or a mixture of finger shape as desired by the therapist in order to accommodate the device to the best possible way required for effective therapy. On those pressure heads with multiple pressure tips or pressure fingers (such as, for instance, pressure heads 38, 280, 340, and 386) the therapist can choose the optimal number, length and shape of pressure tips or fingers in order to have an adapted head for each patient which best matches the size and requirements of the patient's body. The modularity of the system and device allows great flexibility to a practitioner of the art of physical therapy and massage, and provides for improved response of patients to therapy. Another advantage of the modularity of the apparatus and system of the invention is that certain pressure base components may also be useful as pressure heads, and certain pressure heads may function as pressure bases. Depending on the choices of a particular therapist, the entire apparatus of the invention could be inverted at the option of the user, and the pressure transducing and force readout functions would still be operable. Alternatively, attachment of the pressure base components to the pylon could be formed so as to be incompatible with the attachment for the pressure head, and prevent inadvertent exchange of the modular components of the invention.

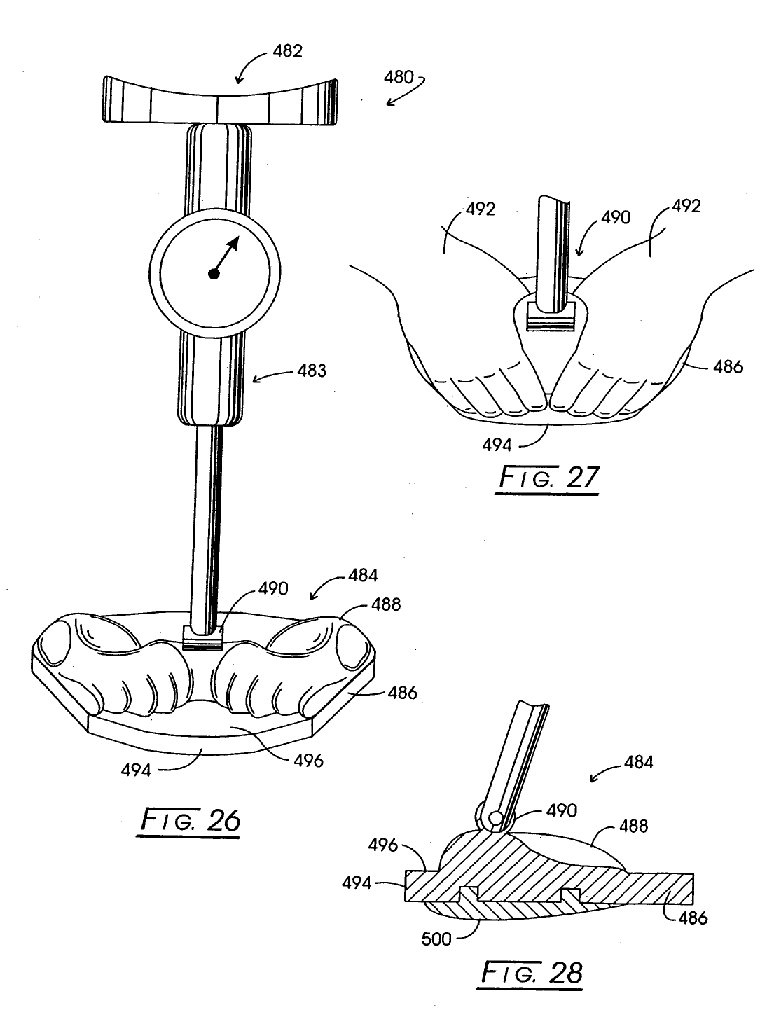

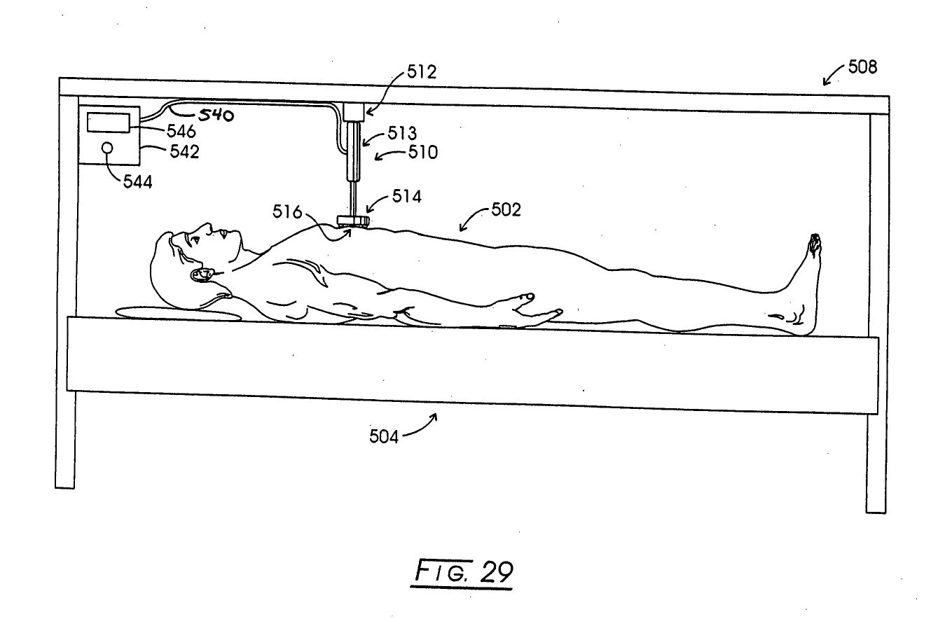

FIGS. 26-28 show a CPT device of the invention, utilizing a variety of the modular components just described. The objective of this CPT device 480 is to support the therapist and allow pressure application while allowing use of the hands during massage of the patient. Pressure base 482 is similar to base 302 shown in FIGS. 11 and 12, with a concave surface that can accommodate the chest or pectoral region of a therapist. Pylon 483 is adapted to transmit force and adapted to determine the applied, received and or delivered pressure. Pressure head body 486 supports paired ergonomic hand grips 488, which may be formed of resilient material, and hinge-swivel 490 is provided to attach pressure head 484 to pylon 483. Hand Surface Massage (HSM) pressure head 484 is formed by a support body 486 which can support the hands of the therapist on the upper surface 496, and bearing on the lower surface 498 are modular accessories with a variety of adapted structures such as pressure surface 500 which are applied on the patient's body. Using the HSM pressure head, the therapist has protection for the hands to avoid injury and to avoid fatigue, allowing therapy to continue for and extended period of time. The hands 492 of the therapist are placed in a double ergonomic grip 488, allowing to have a large surface to apply a pressure massage. Pressure head 486 has a forward margin 494 and an upper surface 496. In one embodiment of the HSM pressure head system, the pressure surface 500 is generally shaped like a human hand, and as such, HSM pressure head 484 is a variation of pressure head 460 seen in FIG. 25. By mimicing a human hand, and providing a means to supply pressure from a source other than the arms, when a practitioner applies force utilizing the weight of the therapist, thus allowing movement of the pressure head 484 by hand motion to induce a massage more or less strong depending of the and the force applied on the base. The hands 492 being free to position the pressure head, the head can be driven about adequately. Pressure head 484 is designed with front margin 494 being close to hand grip 488 so that the hands of the therapist can be in contact with the patient's skin, and manually sense the status of the patient. The device illustrated in FIGS. 26-28 has all the benefits of hand surface massage, but in multi-HSM, there is the added advantage of better handling and control. Furthermore on the lower surface 498 different heads are installed, according to therapist's need. Device 480 provides all the benefits of traditional HSM, yet has a larger surface with ergonomic grips and a variety of detachable heads, providing a more comfortable tool with better patient accessibility.

### EXAMPLES

The following examples are provided to better explain the implementation of the method, system and device of the invention.

### Example 1

In FIG. 29, a patient undergoing CPT therapy, 502, reclines on table 504, with table 504 supported by adjustable frame 508. Patient 502 is receiving therapy through means of CPT therapy device 510. Device 510 is positioned and attached to frame 508 through adjustable pressure base 512, pressure is delivered by actuatable pylon 513 through interchangeable pressure head 514 to patient 502. The pylon component is able to apply different levels of pressure based on the therapist-practitioner's professional assessments of the patient's needs to a chosen pressure point represented at 516. Pressure communicating component 540 is capable of delivering pressurized fluid by which to actuate pylon 513. Pressure communicating component 540 receives pressure in communication with pressure controller 542. Pressure controller 542 may be programmed by the practitioner to deliver the desired pressure, by means of controls, represented in general at 544. Controller 542 also displays a remotely reading pressure indicating means 546, such as a digital display meter or gauge.

Controller 542 can be constructed by those skilled in the art of medical device construction to possess both audible and visual cues to indicated fault modes, should delivered pressure be either too high or too low for effective therapy. In addition, the controls 544 possessed by controller 542 can be constructed to include preset safety limits, so that the system, upon the occurrence of a fault that endangers the safety of the patient, enters a fault mode disabling the pressurization system, thereby avoiding delivery of excess pressure to the patient and causing injury to the patient. As a safety precaution, a deadman automatic stop switch and a manual emergency stop switch are included (but not shown in FIG. 29).

During the use of the CPT therapy system shown in FIG. 29, the practitioner evaluates the patient's needs for CPT therapy. The patient is positioned upon table 504 in such a position that the chosen pressure point, such as that represented at 516, is accessible to the pressure head 514. Thus, the patient could be reclining on the posterior, anterior or either lateral surface of the patient's body. Adjustable pressure base 512 is moved along frame 508 into position above the chosen pressure point, such as 516. Control 544 is adjusted to deliver the pressure chosen by the practitioner, based on experience, previous therapy protocols for the patient, or by means of initial evaluation of the patient. Controller 542 is programmed to deliver the desired pressure, and then delivers to pressure communicating component 540 the means to achieve the desired pressure. Pylon 510, as stated previously could be embodied in a device that is actuated by pneumatic means, hydraulic or other dense fluid, or by means of an electrically actuated drive system, as will be familiar to artisans.

By implementation of programmable controller 542, additional safety and therapy indicators are readily included. Indicating meter or gauge 546 of controller 542 provides feedback to the practitioner as to the pressure delivered (in addition the patient is typically able to indicate when either insufficient or excess pressure is being applied). There are also optional indicators that can be provided on the controller 542 including timers, cumulative force exerted, a stop actuator (to stop the pressure). In another embodiment, the pressure gauge includes a capability to audibly or visually signal to a user that the target pressure to be applied has been reached. In another embodiment of the invention the pressure, force and time parameters may be recorded using a recorder on the gauge. In one such embodiment, the data storing means include means for linking the data recordation feature with a computer, and or means, to transfer the data from the data storing means to a computer along with means to annotate the recorded data with patient indicators, such as name, time and date.

The apparatus in FIG. 29 is shown for illustrative purposes, and bears a superficial similarity in appearance to a variety of existing frames for providing assistance in delivering physical therapy to a patient body. The structure of the frame system of FIG. 29 illustrates the basic concept that a profound, and reproducible pressure can be delivered, and simultaneously measured and or sensed by the apparatus, providing feedback to the therapist. In certain situations, the patient may act as a self-therapist, wherein the attachment of the CPT device is a fixed frame. Because of variation between patients, it is an important aspect of the invention that the pressure transducer can provide to a therapist feedback as to the level of pressure delivered to a patient body when pain is sensed. Devices such as that disclosed in U.S. Pat. No. 6,267,737 to Meilus, neither are adapted for use in the CPT technique, nor to providing feedback to the user of the pressure thresholds applicable for use with CPT therapy.

### Example 2

### Sample Protocols for Utilization of the System and Device of the Invention Including for Use in Rapid Pressure Treatment Modalities

A. Fragile Patient:

1. Skin Contact

2. Pressure X for 3 seconds (Increase slowly to the 3X pressure point)

3. Pressure 3X for 4 seconds;

4. Pressure 2X for 34 seconds

B. Normal Patient (Greater pressures could be used)

1. Skin Contact

2. Pressure X for 3 seconds (Increase slowly to the 3X pressure point)

3. Pressure 4X for 6 seconds;

4. Pressure 3X for 36 seconds

### Example 3

### Pressure Adaptation in Accordance with the Protocol

Soft Protocol or sample protocol for limited force application of the system and device of the invention.

1. At risk patients: e.g. Osteoporosis patients.

1.1 Mild Progressive program: Using the NM Davkor I, apply using a 3 to 5 Kg pressure on the site (using available device). Given that this technique is often painful to sensitive areas, the technique should be applied to an extent that is tolerable to the patient. Maintain the pressure for a few seconds, then reduce the pressure and hold consistently without movement for a period of 15 to 50 seconds. This will produce a feeling of numbness at first, but will slowly reduce or eliminate the pain completely.

2. Not at risk patients.

2.1 Mild Progressive Program: Using the NM Davkor I, apply using a 4 to 7 Kg pressure on the site (using available device). The technique should be applied to an extent that is tolerable to the patient. Maintain the pressure for a few seconds, then reduce the pressure and hold consistently without movement for a period of 20 to 90 seconds. This will produce a feeling of numbness at first, but will slowly reduce or eliminate the pain completely.

2.2 Rapid Reconditioning Program: Using the NM Davkor I, apply using a 5 to 8 Kg pressure on the site. At first the pain may be beyond the patient's tolerance level. Reduce the pressure after a few seconds, but maintain the pressure consistently at the reduced level without movement for a period of 15 to 50 seconds. This will produce a feeling of numbness at first, but will slowly reduce or eliminate the pain completely.

### Example 4

### Utilization of the System and Device for Particular Treatment Targets

The CPT Therapy can be implemented by applying continuous pressure using a device that is outlined below. Through this process, pressure is directed through the skin, using progressive pressure, and is distributed to the tissues. Profound Continuous Pressure Therapy provides a reproducible pressure to the skin and underlying tissues. The system employs a CPT device that allows a therapist to apply a given pressure to specific pressure points. The system is termed “profound” continuous pressure because the pressures applied are typically much greater than that utilized in traditional massage techniques. The Profound CPT method applies pressure to the severe pain threshold of the patient, and then slightly reduces applied pressure so that the pain is reduced. Pressure is maintained according to the protocols provided in the examples above.

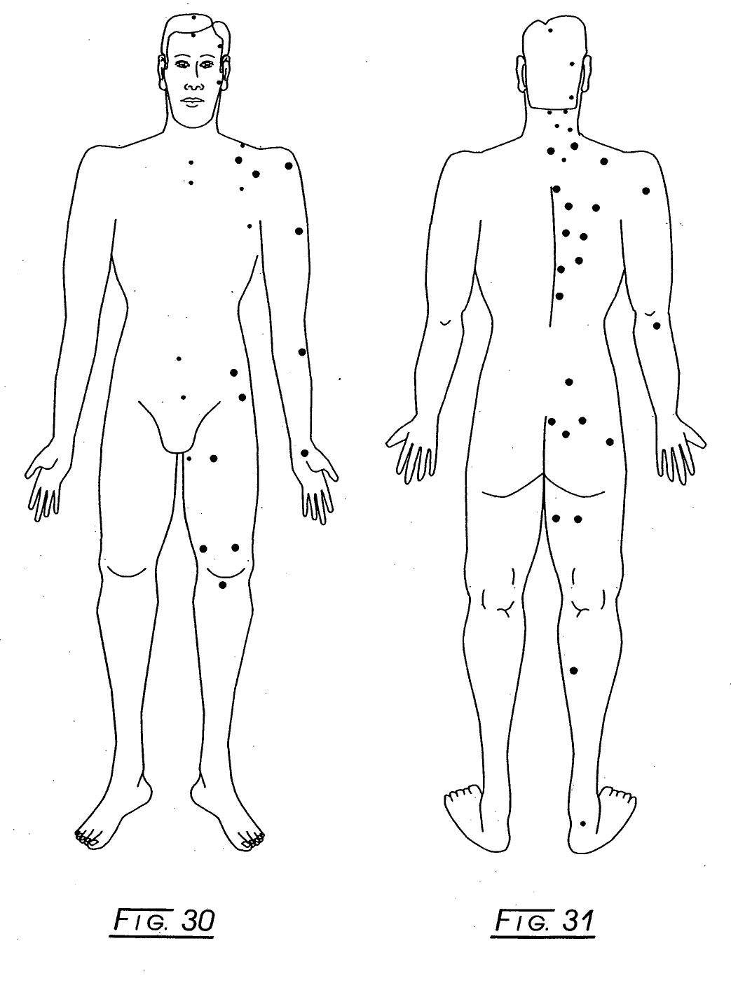

A variety of applications sites can be used for one or all of these areas, including most known physical therapy targets, as described in the detailed description of the invention above. CPT therapy is contraindicated for use on vulnerable body parts such as the face, eyes, abdomen, kidneys, genitals or other sensitive areas. A number of CPT tissue target locations that are particularly adapted to response to CPT therapy are shown in FIGS. 30 and 31.

The therapist using this system and method chooses an appropriate pressure head, and positions the tip/finger of the pressure head against the appropriate pressure point on a patient. The therapist applies pressure to the pressure base, typically by placing the base against the body of the therapist and leaning on the pressure base. Pressure applied by the therapist is transmitted through the pylon to the tip/fingers of pressure head. Position of the tip/fingers can be controlled by the therapist's hand on pylon grip. The level of pressure applied can be monitored by the pressure meter, or by other means, such as by the experience of the therapist, or by the onset of severe pain in the patient. The therapist is enabled by the Davkor device to deliver pressure to target areas of the patient with greater total pressure, for a longer duration and with greater reproducibility than is possible by a therapist utilizing only his/her own fingers.

Since certain changes may be made in the above compositions and methods without departing from the scope of the invention herein involved, it is intended that all matter contained in the above descriptions and examples or shown in the accompanying drawings shall be interpreted as illustrative and not in a limiting sense. All terms not specifically defined herein are considered to be defined according to Dorland's Illustrated Medical Dictionary, 27th edition, or if not defined in Dorland's dictionary then in Webster's New Twentieth Century Dictionary Unabridged, Second Edition. The disclosures of all of the citations provided are being expressly incorporated herein by reference. The disclosed invention advances the state of the art and its many advantages include those described and claimed.

What is claimed is:

1. A device for applying pressure to an animal body at predetermined pressure points, comprising
a) an elongated pressure transmitting pylon, with more than one attachment points;
b) at least one selectable pressure base attached to one attachment point on said pylon;
c) at least one selectable pressure head attached to one attachment point on adapted for applying said pressure to the predetermined pressure point on the body
d) a pressure monitoring component for quantitatively displaying the force being applied to the body at said pressure points by application of force to said pressure base and transmitted through said pylon to said pressure head; and
e) a pressure reporting component for reporting the applied pressure to a user of the device.

2. The device of claim 1 further comprising a pressure reporting component providing for remotely monitoring applied pressure while therapy is in progress.

3. The device of claim 1 wherein the pylon further comprises a spring biased means of transferring and monitoring pressure.

4. The device of claim 1 wherein the pylon further comprises piston compression of a fluid as a means to provide a pressure transducer between the pressure base and the pressure head.

5. The device of claim 4 further comprising a pressure communicating component for delivering pressurized fluid for actuation of said pylon to deliver pressure to the pressure head.

6. The device of claim 4 further comprising a controller providing one or more of audible, visual, and automatic cues for indication of the occurrence of a fault in the delivery of pressure by said device.

7. The device of claim 1 whereby the pressure transmitting pylon is attached to a pressure base affixable to a fixed support capable of resisting force.

8. The device of claim 1 whereby the pressure is remotely reported by an electronic transducer providing a signal of the applied pressure to a remote pressure reporting component.

9. A massage device comprising
a) a pylon with a hand grip and attachment components;
b) a pressure base component with a concave upper surface and attacheable to said pylon;
c) at least one pressure head detachably attached to said pylon for delivering, transmitting, or resisting pressure; and
d) pressure transducing component associated with said pylon effective for transducing pressure between said pressure base and said pressure head.

10. The pressure head of claim 9 further comprising
a) a component for engaging a pylon;
b) an upper flattened surface with grips formed for engaging a hand; and
c) a lower surface formed of resilient material of convex shape.

11. The pressure head of claim 9 further comprising an adjustable pressure head with a
a) a pressure head body;
b) a pylon attachment component associated with said pressure head body;
c) more than one pressure finger engaged with said pressure head body; and
d) at least one positionable pressure head body sliders detachably engaged with said pressure head body and with at least one pressure finger.

12. The pressure head of claim 9 further comprising
a) a pressure head body of rigid material;
b) a pylon attachment component positionable about one or more of a pivot, a hinge, a ball and socket and a swivel associated with said pressure head body; and
c) a heel of resilient material attached to said pressure head body.

13. A method for providing physical therapy comprising
a. determining a target tissue in need of therapy;
b. selecting a pressure applicator capable of providing quantitiative feedback as to the applied pressure for providing applied pressure;
c. selecting a pressure delivery component through which to apply pressure delivered by said pressure applicator;
d. applying a predetermined amount of a profound pressure to a patient; and
e. continuously maintaining the applied profound pressure for more than 30 seconds.

14. The method of claim 13 wherein feedback of the applied pressure is continuously provided by a remote pressure transducer.

15. The method of claim 13 wherein said profound pressure is delivered by a device comprising an elongated pylon, with more than one attachment points; at least one selectable pressure base attached to one attachment point on said pylon; and at least one selectable pressure head attached to one attachment point on said pylon, such that a practitioner is capable of delivering profound pressure one or more of reproducibly, repeatedly and for greater application time than would be practicable without use of said device.

16. The method of claim 13 wherein the pressure applicator further comprises piston compression of a fluid as a means to provide a pressure transducer between the pressure delivery component and a patient.

17. The method of claim 16 further comprising a pressure communicating component for delivering pressurized fluid for actuation of said pressure applicator to deliver pressure to the pressure delivery component.

18. The method of claim 13 further comprising a controller device providing one or more of audible, visual, and automatic cues for indication of the delivery of pressure by said device.

19. The method of claim 18 whereby the cue for indication is audible.

20. The device of claim 13 whereby the pressure is delivered under the control of the patient.
